(19) United States
(12) Patent Application Publication
(10) Pub. No.: US 2022/0282074 A1
(43) Pub. Date: Sep. 8, 2022

(54) SINGLE SITE CATALYSED MULTIMODAL POLYETHYLENE COMPOSITION

(71) Applicants: ABU DHABI POLYMERS CO. LTD (BOROUGE) L.L.C.,, Abu Dhabi (AE); Borealis AG, Vienna (AT)

(72) Inventors: Raghvendra Singh, Abu Dhabi (AE); Tariq Hashim Abu Foul, Abu Dhabi (AE); Pankaj Verma, Abu Dhabi (AE); Pratyush Bandyopadhyay, Vashi, Navi Mumbai (IN); Niraj Dixit, Goregaon (E), Mumbai (IN)

(21) Appl. No.: 17/628,324

(22) PCT Filed: Jul. 8, 2020
(86) PCT No.: PCT/EP2020/069282

§ 371 Date: Jan. 19, 2022

(30) Foreign Application Priority Data
Jul. 22, 2019 (EP) 19187632.5

(51) Int. Cl. C08L 23/08

(52) U.S. Cl. CPC C08L 23/0815; C08L 2205/03; C08L 2203/16

(57) ABSTRACT

The present invention relates to a polyethylene composition comprising a base resin, wherein the base resin comprises (A) a first ethylene-1-butene copolymer fraction (A) having a 1-butene content of from 0.5 wt % to 7.5 wt %, based on the total weight amount of monomer units in the first ethylene-1-butene copolymer fraction (A), and a melt flow rate MFR2 in the range of from 1.0 to less than 50.0 g/10 min, determined according to ISO 1133 at a temperature of 190° C. and a load of 2.16 kg; and (B) a second ethylene-1-butene copolymer fraction having a higher 1-butene content as the first ethylene-1-butene copolymer fraction (B); wherein the base resin is polymerized in the presence of a single site catalyst system and has a density of from 913.0 to 920.0 kg/m³ and a 1-butene content of from 8.0 to 13.0 wt %, based on the total weight amount of monomer units in the base resin, a process for preparing said polyethylene composition, an article comprising said polyethylene composition and the use of said polyethylene composition for the production of an article.

The present invention relates to a polyethylene composition comprising two single site catalysed ethylene-1-butene copolymer fractions with different 1-butene content, a process for preparing said polyethylene composition, an article comprising said polyethylene composition and the use of said polyethylene composition for the production of an article.

### BACKGROUND OF THE INVENTION

For soft packaging applications such as film applications usually polyethylene resins produced in the presence of single site catalysts such as metallocene catalysts are used. Single-site catalysed polyethylene resins show a unique set of properties in regard of optical and mechanical properties, which are especially suitable for film applications.

Unimodal polyethylene resins for instance have good properties, like low haze but show a rather poor melt processing which can cause quality problems in the final product.

Multimodal polyethylene resins with two or more different polymer components are better to process, but the melt homogenisation of the multimodal polyethylene may be problematic resulting in an inhomogeneous final product as evidenced by e.g. a high gel content of the final product.

WO 00/40620 discloses a process for producing polyethylene compositions in the presence of a single site catalyst. WO 99/35652 relates to an insulating composition comprising a crosslinkable multimodal ethylene copolymer obtained by coordination catalysed polymerisation of ethylene and at least one other alpha-olefin. EP 3331950 relates to compatible heterogeneous polyamide-polyethylene blends comprising a matrix comprising a linear low density polyethylene.

WO 2016/083208 discloses a multimodal polyethylene composition with at least two different comonomers, such as 1-butene and 1-hexene, which shows an excellent balance of properties in regard of processability, mechanical properties, sealing properties and optical properties.

In the present invention it has surprisingly been found that a comparable balance of properties as for the multimodal polyethylene composition with at least two different comonomers of WO 2016/083208 can be obtained by a polyethylene composition comprising two ethylene-1-butene copolymers polymerized in the presence of a single site catalyst system, which differ in their 1-butene content and their melt flow rates.

Usually, polyethylene compositions only with 1-butene as comonomer show inferior mechanical properties especially in regard of tear strength and impact properties compared to polyethylene compositions which additionally comprise 1-hexene comonomer. Additionally, polyethylene compositions only with 1-butene as comonomer show inferior optical and heat sealing properties compared to polyethylene compositions which additionally comprise 1-hexene comonomer.

In the present invention it has surprisingly been found that by carefully tailoring the 1-butene contents and melt flow rates of the two ethylene-1-butene copolymers a polyethylene composition can be obtained with an improved balance of properties in regard of processability, mechanical properties, sealing properties and optical properties which is comparable to that of polyethylene composition with at least two different comonomers, such as 1-butene and 1-hexene.

### SUMMARY OF THE INVENTION

The present invention relates to a polyethylene composition comprising a base resin, wherein the base resin comprises
(A) a first ethylene-1-butene copolymer fraction (A) having a 1-butene content of from 0.5 wt % to 7.5 wt %, based on the total weight amount of monomer units in the first ethylene-1-butene copolymer fraction (A), and a melt flow rate MFR₂ in the range of from 1.0 to less than 50.0 g/10 min, determined according to ISO 1133 at a temperature of 190° C. and a load of 2.16 kg; and
(B) a second ethylene-1-butene copolymer fraction (B) having a higher 1-butene content than the first ethylene-1-butene copolymer fraction;
wherein the base resin is polymerized in the presence of a single site catalyst system and has a density of from 913.0 to 920.0 kg/m³ and a 1-butene content of from 8.0 to 13.0 wt %, based on the total weight amount of monomer units in the base resin.

The present invention further relates to a process for preparing a polyethylene composition as defined above or below comprising the steps of:
a) polymerizing ethylene and 1-butene monomers in the presence of a single site catalyst system in a first polymerization reactor to form a first polymerization mixture comprising a first ethylene-1-butene copolymer fraction (A) having a 1-butene content of from 0.5 wt % to 7.5 wt %, based on the total weight amount of monomer units in the first ethylene-1-butene copolymer fraction (A) and a melt flow rate MFR₂ in the range of from 1.0 to less than 50.0 g/10 min, determined according to ISO 1133 at a temperature of 190° C. and a load of 2.16 kg, and said single site catalyst;
b) transferring the first polymerization mixture from the first polymerization reactor to a second polymerization reactor;
c) polymerizing ethylene and 1-butene monomers in the presence of a single site catalyst in said second polymerization reactor to form a second polymerization mixture comprising said first ethylene-1-butene copolymer fraction (A) and a second ethylene-1-butene copolymer fraction (B);
d) recovering said second polymerization mixture from said second reactor;
e) forming a base resin having a density of from 913.0 to 920.0 kg/m³ and a 1-butene content of from 8.0 to 13.0 wt %, based on the total weight amount of monomer units in the base resin, and
f) preparing the polyethylene composition.

Still further, the present invention relates to an article comprising the polyethylene composition as defined above or below.

Additionally, the present invention relates to the use of the polyethylene composition as defined above or below for the production of an article.

### Definitions

A polyethylene composition according to the present invention denotes a polymer derived from more than 50 mol-% ethylene monomer units and optionally additional comonomer units.

The term ‘copolymer’ denotes a polymer derived from ethylene monomer units and additional comonomer units in an amount of more than 0.05 mol %.

A polyethylene composition or base resin comprising more than one fraction differing from each other in at least one property, such as weight average molecular weight or comonomer content, is called “multimodal”. If the multimodal polyethylene composition or base resin includes two different fractions, it is called “bimodal” and, correspondingly, if it includes three different fractions, it is called “trimodal”. The form of the molecular weight distribution curve, i.e. the appearance of the graph of the polymer weight fraction as function of its molecular weight, of such a multimodal polyethylene composition or base resin will show two or more maxima depending on the modality or at least be distinctly broadened in comparison with the curves of the individual fractions.

In the present invention the two ethylene-1-butene copolymer fractions differ not only in their molecular weights which can been in their melt flow rates MFR₂ but also in their 1-butene contents.

The term ‘base resin’ denotes the polymeric part of the polyethylene composition without usual additives for utilization with polyolefins, such as stabilizers (e.g. antioxidant agents), antacids and/or anti-UV's, may be present in the polyethylene composition. Preferably, the total amount of these additives is 1.0 wt % or below, more preferably 0.5 wt % or below, most preferably 0.25 wt % or below, of the composition.

### DETAILED DESCRIPTION

Base Resin

The base resin according to the present invention comprises two ethylene-1-butene copolymer fractions (A) and (B).

The first ethylene-1-butene copolymer fraction (A) has a 1-butene content of from 0.5 wt % to 7.5 wt %, preferably from 0.6 wt % to 5.0 wt %, still more preferably from 0.7 wt % to 3.5 wt % and most preferably from 0.8 wt % to 3.0 wt %, based on the total weight amount of monomer units in the first ethylene-1-butene copolymer fraction (A).

The first ethylene-1-butene copolymer fraction (A) preferably has a density of from 915 kg/m³ to 955 kg/m³, more preferably of from 925 kg/m³ to 950 kg/m³, and most preferably of from 935 kg/m³ to 945 kg/m³.

The first ethylene-1-butene copolymer fraction (A) preferably consists of ethylene and 1-butene monomer units.

The first ethylene-1-butene copolymer fraction (A) has a melt flow rate MFR₂ of from 1.0 g/10 min to less than 50.0 g/10 min, preferably of from 2.0 g/10 min to 45.0 g/10 min, still more preferably of from 3.0 g/10 min to 30.0 g/10 min, even more preferably of from 3.5 g/10 min to 20.0 g/10 min and most preferably of from 4.0 g/10 min to 10.0 g/10 min.

It is preferred that the first ethylene-1-butene copolymer fraction (A) has a higher melt flow rate MFR₂ than the second ethylene-1-butene copolymer fraction (B). It is further preferred that the first ethylene-1-butene copolymer fraction (A) has a higher melt flow rate MFR₂ than the polyethylene composition.

The first ethylene-1-butene copolymer fraction (A) preferably has a melt flow rate MFR₂₁ of from 60 g/10 min to less than 150 g/10 min, preferably of from 65 g/10 min to 140 g/10 min, still more preferably of from 75 g/10 min to 130 g/10 min, and most preferably of from 85 g/10 min to 120 g/10 min.

It is preferred that the first ethylene-1-butene copolymer fraction (A) has a higher melt flow rate MFR₂₁ than the second ethylene-1-butene copolymer fraction (B). It is further preferred that the first ethylene-1-butene copolymer fraction (A) has a higher melt flow rate MFR₂₁ than the polyethylene composition.

The higher MFR₂ and/or MFR₂₁ values of the first ethylene-1-butene copolymer fraction (A) indicate a lower molecular weight, such as a lower weight average molecular weight Mw of the first ethylene-1-butene copolymer fraction (A) compared to the second ethylene-1-butene copolymer fraction (B) and/or the polyethylene composition.

Preferably, the first ethylene-1-butene copolymer fraction (A) has a flow rate ratio, being the ratio of the melt flow rates MFR₂₁/MFR₂, of from 10 to 25, more preferably of from 12 to 22, and most preferably of from 15 to 20.

The first ethylene-1-butene copolymer fraction (A) is preferably present in the base resin in an amount of from 30 to 47 wt %, more preferably of from 32 to 46 wt % and most preferably from 35 to 45 wt %, based on the total weight of the base resin.

The first ethylene-1-butene copolymer fraction (A) is usually polymerized as the first polymer fraction in a multistage polymerization process with two or more polymerization stages in sequence. Consequently, the properties of the first ethylene-1-butene copolymer fraction (A) can be measured directly.

The second ethylene-1-butene copolymer fraction (B) preferably has a 1-butene content of from 10.0 wt % to 25.0 wt %, more preferably from 12.5 wt % to 22.0 wt %, still more preferably from 15.0 wt % to 20.0 wt % and most preferably from 16.0 wt % to 18.5 wt %, based on the total weight amount of monomer units in the second ethylene-1-butene copolymer fraction (B).

The second ethylene-1-butene copolymer fraction (B) preferably has a density of from 870 kg/m³ to 912 kg/m³, more preferably of from 880 kg/m³ to 910 kg/m³, and most preferably of from 890 kg/m³ to 905 kg/m³.

The second ethylene-1-butene copolymer fraction (B) preferably consists of ethylene and 1-butene monomer units.

The second ethylene-1-butene copolymer fraction (B) preferably has a melt flow rate MFR₂ of from 0.05 g/10 min to less than 1.0 g/10 min, more preferably of from 0.1 g/10 min to 0.8 g/10 min, still more preferably of from 0.2 g/10 min to 0.7 g/10 min, and most preferably of from 0.3 g/10 min to 0.6 g/10 min, determined according to ISO 1133.

It is further preferred that the second ethylene-1-butene copolymer fraction (B) has a lower melt flow rate MFR₂ as the polyethylene composition.

The lower MFR₂ and/or MFR₂₁ values of the second ethylene-1-butene copolymer fraction (B) indicate a higher molecular weight, such as a higher weight average molecular weight Mw of the second ethylene-1-butene copolymer fraction (B) compared to the first ethylene-1-butene copolymer fraction (A) and/or the polyethylene composition.

The second ethylene-1-butene copolymer fraction (B) is usually polymerized as the second polymer fraction in the presence of the first ethylene-1-butene copolymer fraction (A) in a multistage polymerization process with two or more polymerization stages in sequence. Consequently, the properties of the second ethylene-1-butene copolymer fraction (B) are not accessible to direct measurement but have to be calculated. Suitable methods for calculating the comonomer content, density and MFR₂ of the second ethylene-1-butene copolymer fraction (B) are listed below under Determination methods.

The second ethylene-1-butene copolymer fraction (B) is preferably present in the base resin in an amount of from 43 to 65 wt %, more preferably of from 44 to 62 wt % and most preferably from 45 to 60 wt %, based on the total weight of the base resin.

The weight ratio of the first ethylene-1-butene copolymer fraction (A) to the second ethylene-1-butene copolymer fraction (B) in the base resin is preferably from 35:65 to 47:53, more preferably from 37:63 to 46:54 and most preferably from 40:60 to 45:55.

In one preferred embodiment of the present invention the base resin consists of the first ethylene-1-butene copolymer fraction (A) and the second ethylene-1-butene copolymer fraction (B).

In another embodiment of the present invention the base resin further comprises up to 15 wt %, preferably from 2.5 to 15.0 wt %, more preferably from 5.0 to 13.0 wt % and most preferably from 7.5 to 12.5 wt % of polymer(s) different from the first and second ethylene-1-butene copolymer fractions (A) and (B).

Preferably said polymer(s) different from the first and second ethylene-1-butene copolymer fractions (A) and (B) are selected from alpha-olefin homo- or copolymers). One especially suitable polymer different from the first and second ethylene-1-butene copolymer fractions (A) and (B) is low density polyethylene (LDPE). A low density polyethylene is an ethylene based polymer, optionally including further comonomers, which is polymerized in a high pressure process. Such high pressure processes are well known in the art. The optional low density polyethylene can also be commercially available.

The base resin of the polyethylene composition of the invention has a 1-butene content of from 8.0 wt % to 13.0 wt %, preferably from 8.3 wt % to 12.0 wt %, still more preferably from 8.5 wt % to 11.5 wt %, even more preferably from 8.7 wt % to 11.0 wt %, and most preferably from 9.0 to 11.0 wt %, based on the total weight amount of monomer units in the base resin.

The base resin of the polyethylene composition of the invention has a density of from 913.0 kg/m³ to 920.0 kg/m³ and preferably of from 914.0 kg/m³ to 918.0 kg/m³.

The base resin preferably has a melt flow rate MFR₂ of from 0.7 g/10 min to 4.0 g/10 min, preferably of from 0.9 g/10 min to 3.0 g/10 min, still more preferably of from 1.0 g/10 min to 2.5 g/10 min, even more preferably of from 1.1 g/10 min to 2.0 g/10 min and most preferably of from 1.2 g/10 min to 1.8 g/10 min.

The base resin preferably has a melt flow rate MFR₂₁ of from 15 g/10 min to less than 50 g/10 min, preferably of from 17 g/10 min to 45 g/10 min, still more preferably of from 19 g/10 min to 40 g/10 min, and most preferably of from 20 g/10 min to 35 g/10 min.

Preferably, the base resin has a flow rate ratio FRR_{2U5}, being the ratio of the melt flow rates MFR₂₁/MFR₂, of from 10 to 30, more preferably of from 12 to 27, and most preferably of from 15 to 25.

The base resin is preferably present in the polyethylene composition of the present invention in an amount of at least 95 wt %, such as from 95.0 wt % to 100 wt %, more preferably from 99.0 wt % to 99.95 wt %, still more preferably from 99.5 wt % to 99.95 wt %, and most preferably from 99.75 wt % to 99.95 wt %, of the polyethylene composition.

Preferably, the base resin does not comprise 1-hexene.

Polyethylene Composition

The polyethylene composition can further contain additives and/or fillers. It is noted herein that additives may be present in the polymer of ethylene (a) and/or mixed with the base resin in a compounding step for producing the polyethylene composition.

Examples of such additives are, among others, antioxidants, process stabilizers, UV-stabilizers, pigments, fillers, antistatic additives, antiblock agents, nucleating agents, acid scavengers, slip agent as well as polymer processing agent (PPA). Preferably, the total amount of these additives is 1.0 wt % or below, more preferably 0.5 wt % or below, most preferably 0.25 wt % or below, of the polyethylene composition.

It is understood herein that any of the additives and/or fillers can optionally be added in so called master batch which comprises the respective additive(s) together with a carrier polymer. In such case the carrier polymer is not calculated to the base resin of the polyethylene composition, but to the amount of the respective additive(s), based on the total amount of polyethylene composition.

The polyethylene composition is characterized by the following properties: MFR₂

The polyethylene composition preferably has a melt flow rate MFR₂ (190° C., 2.16 kg) of from 0.7 g/10 min to 4.0 g/10 min, more preferably of from 0.9 g/10 min to 3.0 g/10 min, still more preferably of from 1.0 g/10 min to 2.5 g/10 min, even more preferably of from 1.1 g/10 min to 2.0 g/10 min and most preferably of from 1.2 g/10 min to 1.8 g/10 min, determined according to ISO 1133.

MFR₂₁

The polyethylene composition preferably has a melt flow rate MFR₂₁ (190° C., 21.6 kg) of from 15 g/10 min to less than 50 g/10 min, preferably of from 20 g/10 min to 45 g/10 min, still more preferably of from 23 g/10 min to 40 g/10 min, and most preferably of from 25 g/10 min to 35 g/10 min, determined according to ISO 1133.

FRR_{21/2}

The polyethylene composition preferably has a flow rate ratio FRR_{21/2}, being the ratio of MFR₂₁ to MFR₂, of from 10 to 30, more preferably of from 12 to 27, and most preferably of from 15 to 25.

Molecular Weight Distribution Mw/Mn

The polyethylene composition has preferably a polydispersity index PDI, being the ratio of weight average molecular weight Mw to number average molecular weight Mn, Mw/Mn, in the range of 3.0 to 8.0, more preferably in the range of 3.5 to 7.5 and most preferably in the range of 4.0 to 6.0.

Density

The polyethylene composition has a density of from 913.0 kg/m³ to 920.0 kg/m³ and preferably of from 914.0 kg/m³ to 919.0 kg/m³, determined according to ISO 1183-1:2004.

The density of the base resin is mainly influenced by the amount and type of comonomer. In addition to that, the nature of the polymer originating mainly from the catalyst used as well as the melt flow rate play a role.

In one embodiment, the present invention relates to a polyethylene composition comprising a base resin, wherein the base resin comprises
(A) a first ethylene-1-butene copolymer fraction (A) having a 1-butene content of from 0.5 wt % to 7.5 wt %, based on the total weight amount of monomer units in the first ethylene-1-butene copolymer fraction (A), and a melt flow rate MFR₂ in the range of from 1.0 to less than 50.0 g/10 min, determined according to ISO 1133 at a temperature of 190° C. and a load of 2.16 kg; and
(B) a second ethylene-1-butene copolymer fraction (B) having a 1-butene content of from 10.0 wt % to 25.0 wt %, based on the total weight amount of monomer units in the second ethylene-1-butene copolymer fraction (B), and a melt flow rate MFR₂ of from 0.05 g/10 min to less than 1.0 g/10 min, determined according to ISO 1133 at a temperature of 190° C. and a load of 2.16 kg;
wherein the base resin is polymerized in the presence of a single site catalyst system and has a density of from 913.0 to 920.0 kg/m³ and a 1-butene content of from 8.0 to 13.0 wt %, based on the total weight amount of monomer units in the base resin.

Article

In yet a further aspect, the present invention is concerned with an article comprising the polyethylene composition as described above or below, obtainable by a process as described above or below and the use of such a polyethylene composition for the production of an article.

The article preferably is a film or a blow molded article or a rotomoulded article. It is especially preferred that the article is a film, such as a blown film or a cast film or a multi-layered film. In a multi-layered film the polyethylene composition is preferably comprised in one or more layers of the multi-layered film.

Films comprising the polyethylene composition according to the invention are preferably characterized by the following properties:

Tensile Modulus in Machine Direction (TM-MD)

A film comprising the polyethylene composition according to the invention preferably has a tensile modulus in machine direction (TM-MD) of at least 150 MPa, more preferably at least 175 MPa, when measured on a 40 μm blown film according to ASTM D882 at a test speed of 5 mm/min and a strain of 1%. The upper limit of the tensile modulus in machine direction is usually not higher than 500 MPa, preferably not higher than 300 MPa.

Tensile Modulus in Transverse Direction (TM-TD)

A film comprising the polyethylene composition according to the invention preferably has a tensile modulus in transverse direction (TM-TD) of at least 175 MPa, more preferably at least 200 MPa, and most preferably at least 225 MPa, when measured on a 40 μm blown film according to ASTM D882 at a test speed of 5 mm/min and a strain of 1%. The upper limit of the tensile modulus in transverse direction is usually not higher than 500 MPa, preferably not higher than 350 MPa.

Tensile Stress at Break in Machine Direction (TSB-MD)

A film comprising the polyethylene composition according to the invention preferably has a tensile stress at break in machine direction (TSB-MD) of at least 30 MPa, more preferably at least 35 MPa, and most preferably at least 40 MPa, when measured on a 40 μm blown film according to ISO 527-3:1996 at a test speed of 500 mm/min. The upper limit of the tensile stress at break in machine direction is usually not higher than 100 MPa, preferably not higher than 75 MPa.

Tensile Stress at Break in Transverse Direction (TSB-TD)

A film comprising the polyethylene composition according to the invention preferably has a tensile stress at break in transverse direction (TSB-TD) of at least 25 MPa, more preferably at least 30 MPa, and most preferably at least 32 MPa, when measured on a 40 μm blown film according to ISO 527-3:1996 at a test speed of 500 mm/min. The upper limit of the tensile stress at break in transverse direction is usually not higher than 100 MPa, preferably not higher than 75 MPa.

Tensile Stress at Yield in Machine Direction (TSY-MD)

A film comprising the polyethylene composition according to the invention preferably has a tensile stress at yield in machine direction (TSY-MD) of at least 10 MPa, more preferably at least 12 MPa, and most preferably at least 13 MPa, when measured on a 40 μm blown film according to ISO 527-3:1996 at a test speed of 500 mm/min. The upper limit of the tensile stress at yield in machine direction is usually not higher than 40 MPa, preferably not higher than 30 MPa.

Tensile Stress at Yield in Transverse Direction (TSY-TD)

A film comprising the polyethylene composition according to the invention preferably has a tensile stress at yield in transverse direction (TSY-TD) of at least 8.0 MPa, more preferably at least 9.0 MPa, and most preferably at least 10.0 MPa, when measured on a 40 μm blown film according to ISO 527-3:1996 at a test speed of 500 mm/min. The upper limit of the tensile stress at yield in transverse direction is usually not higher than 40 MPa, preferably not higher than 30 MPa.

Elongation at Break in Machine Direction (EB-MD)

A film comprising the polyethylene composition according to the invention preferably has an elongation at break in machine direction (EB-MD) of at least 500%, more preferably at least 550%, and most preferably at least 575%, when measured on a 40 μm blown film according to ISO 527-3:1996 at a test speed of 500 mm/min. The upper limit of the elongation at break in machine direction is usually not higher than 850%, preferably not higher than 800%.

Elongation at Break in Transverse Direction (EB-TD)

A film comprising the polyethylene composition according to the invention preferably has an elongation at break in transverse direction (EB-TD) of at least 650%, more preferably at least 675%, and most preferably at least 700%, when measured on a 40 μm blown film according to ISO 527-3:1996 at a test speed of 500 mm/min. The upper limit of the elongation at break in transverse direction is usually not higher than 1000%, preferably not higher than 900%.

Elmendorf Tear Strength in Machine Direction (TS-MD)

A film comprising the polyethylene composition according to the invention preferably has an Elmendorf tear strength in machine direction (TS-MD) of at least 0.6 N, more preferably at least 0.7 N, and most preferably at least 0.8 N, when measured on a 40 μm blown film according to ISO 6383-2:1983. The upper limit of Elmendorf tear strength in machine direction is usually not higher than 5.0 N, preferably not higher than 4.0 N.

Elmendorf Tear Strength in Transverse Direction (TS-TD)

A film comprising the polyethylene composition according to the invention preferably has an Elmendorf tear strength in transverse direction (TS-TD) of at least 5.0 N, more preferably at least 5.5 N, and most preferably at least 6.0 N, when measured on a 40 μm blown film according to ISO 6383-2:1983. The upper limit of Elmendorf tear strength in transverse direction is usually not higher than 20.0 N, preferably not higher than 15.0 N.

Elmendorf Tear Strength in Machine Direction (TS-MD)

A film comprising the polyethylene composition according to the invention preferably has an Elmendorf tear strength in machine direction (TS-MD) of at least 50 g, more preferably at least 60 g, and most preferably at least 75 g, when measured on a 40 μm blown film according to ISO 6383-2:1983. The upper limit of Elmendorf tear strength in machine direction is usually not higher than 500 g, preferably not higher than 400 g.

Elmendorf Tear Strength in Transverse Direction (TS-TD)

A film comprising the polyethylene composition according to the invention preferably has an Elmendorf tear strength in transverse direction (TS-TD) of at least 600 g, more preferably at least 625 g, and most preferably at least 650 g, when measured on a 40 μm blown film according to ISO 6383-2:1983. The upper limit of Elmendorf tear strength in transverse direction is usually not higher than 1000 g, preferably not higher than 900 g.

Puncture Resistance—Maximum Force (PRF-Max)

A film comprising the polyethylene composition according to the invention preferably has a puncture resistance—maximum force (PRF-max) of at least 20 N, more preferably at least 22 N, and most preferably at least 25 N, when measured on a 40 μm blown film according to ASTM D5758 at a test speed of 250 mm/min. The upper limit of the puncture resistance—maximum force (PRF-max) is usually not higher than 60 N, preferably not higher than 55 N.

Puncture Resistance—Force at Break (PRF-Break)

A film comprising the polyethylene composition according to the invention preferably has a puncture resistance—force at break (PRF-break) of at least 20 N, more preferably at least 22 N, and most preferably at least 25 N, when measured on a 40 μm blown film according to ASTM D5758 at a test speed of 250 mm/min. The upper limit of the puncture resistance—force at break (PRF-break) is usually not higher than 60 N, preferably not higher than 55 N.

Puncture Resistance—Energy at Break (PRE)

A film comprising the polyethylene composition according to the invention preferably has a puncture resistance—energy at break (PRE) of at least 0.50 J, more preferably at least 0.55 J, and most preferably at least 0.60 J, when measured on a 40 μm blown film according to ASTM D5758 at a test speed of 250 mm/min. The upper limit of the puncture resistance—energy at break (PRE) is usually not higher than 5.0 J, preferably not higher than 4.5 J.

Puncture Resistance—Travel at Break (PRT)

A film comprising the polyethylene composition according to the invention preferably has a puncture resistance—travel at break (PRT) of not more than 100 mm, more preferably not more than 90 mm, and most preferably not more than 85 mm, when measured on a 40 μm blown film according to ASTM D5758 at a test speed of 250 mm/min. The lower limit of the puncture resistance—travel at break (PRT) is usually at least 30 mm, preferably at least 40 mm.

Dart Drop Impact (DDI)

A film comprising the polyethylene composition according to the invention preferably has a dart drop impact (DDI) of at least 100 g, more preferably at least 125 g and most preferably at least 150 g, when measured on a 40 μm blown film. The upper limit of the dart drop impact is usually not more than 500 g, preferably not more than 450 g.

Sealing Initiation Temperature (SIT)

A film comprising the polyethylene composition according to the invention preferably has a sealing initiation temperature (SIT) of not more than 100° C., more preferably not more than 98° C., most preferably not more than 97° C., when measured on a 40 μm blown film. The lower limit of the sealing initiation temperature (SIT) is usually at least 90° C., more preferably at least 92° C.

Hot Tack Temperature

A film comprising the polyethylene composition according to the invention preferably has a hot tack temperature of at least 88.0° C., more preferably of at least 90° C., most preferably of at least 92° C., when measured on a 40 μm blown film. The upper limit of the hot tack temperature is usually not more than 97° C., more preferably not more than 95° C.

Haze

A film comprising the polyethylene composition according to the invention preferably has a haze of not more than 14.0%, more preferably not more than 13.0%, and most preferably not more than 12.0%, when measured on a 40 μm blown film according to ASTM D1003. The lower limit of the haze is usually at least 2.0%, more preferably at least 3.0%.

Gloss

A film comprising the polyethylene composition according to the invention preferably has a gloss of at least 92.0%, more preferably of at least 95.0%, most preferably of at least 98.0%, when measured according to ISO 2813 on the inside surface of a 40 μm blown film. The upper limit of the gloss is usually not more than 115%, more preferably not more than 110%.

Gel Content

A film comprising the polyethylene composition according to the invention preferably has not more than 10 gels/m², more preferably 6 gels/m² and most preferably no gels/m² of more than 999 μm diameter, when measured on a 70 μm cast film.

A film comprising the polyethylene composition according to the invention preferably has not more than 100 gels/m², more preferably not more than 60 gels/m² and most preferably not more than 1.0 gels/m² of 600-999 μm diameter, when measured on a 70 μm cast film. The lower limit for the content of gels of 600-999 μm diameter is usually not lower than 0.01 gels/m², more preferably not lower than 0.1 gels/m².

A film comprising the polyethylene composition according to the invention preferably has not more than 250 gels/m², more preferably not more than 200 gels/m² and most preferably not more than 170 gels/m² of 300-599 μm diameter, when measured on a 70 μm cast film. The lower limit for the content of gels of 300-599 μm diameter is usually not lower than 5 gels/m², more preferably not lower than 7 gels/m².

A film comprising the polyethylene composition according to the invention preferably has not more than 500 gels/m², more preferably not more than 400 gels/m² and most preferably not more than 100 gels/m² of 100-299 μm diameter, when measured on a 70 μm cast film. The lower limit for the content of gels of 100-299 μm diameter is usually not lower than 10 gels/m², more preferably not lower than 20 gels/m².

Process

The polyethylene composition is produced in a process, wherein the first and second ethylene-1-butene copolymers (A) and (B) are polymerized in a multistage process in at least two sequential reactor stages in any order in the presence of a single site catalyst system.

Single Site Catalyst System

The first and second ethylene-1-butene copolymers (A) and (B) are preferably produced using a single site catalyst system, which includes metallocene catalyst and non-metallocene catalyst, which all terms have a well-known meaning in the art. The term “single site catalyst system” means herein the catalytically active metallocene compound or complex combined with a cocatalyst. The metallocene compound or complex is referred herein also as organometallic compound.

The organometallic compound comprises a transition metal (M) of Group 3 to 10 of the Periodic Table (IUPAC 2007) or of an actinide or lanthanide.

The term “an organometallic compound” in accordance with the present invention includes any metallocene or non-metallocene compound of a transition metal which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment the organometallic compound has the following formula (I):

(L)ₘRₙMX_{q} (I)
wherein
“M” is a transition metal (M) transition metal (M) of Group 3 to 10 of the Periodic Table (IUPAC 2007),
each “X” is independently a monoanionic ligand, such as a σ-ligand,
each “L” is independently an organic ligand which coordinates to the transition metal
“M”,
“R” is a bridging group linking said organic ligands (L),
“m” is 1, 2 or 3, preferably 2
“n” is 0, 1 or 2, preferably 1,
“q” is 1, 2 or 3, preferably 2 and
m+q is equal to the valency of the transition metal (M).

“M” is preferably selected from the group consisting of zirconium (Zr), hafnium (Hf), or titanium (Ti), more preferably selected from the group consisting of zirconium (Zr) and hafnium (Hf). “X” is preferably a halogen, most preferably Cl.

Most preferably the organometallic compound is a metallocene complex which comprises a transition metal compound, as defined above, which contains a cyclopentadienyl, indenyl or fluorenyl ligand as the substituent “L”. Further, the ligands “L” may have substituents, such as alkyl groups, aryl groups, arylalkyl groups, alkylaryl groups, silyl groups, siloxy groups, alkoxy groups or other heteroatom groups or the like. Suitable metallocene catalysts are known in the art and are disclosed, among others, in WO-A-95/12622, WO-A-96/32423, WO-A-97/28170, WO-A-98/32776, WO-A-99/61489, WO-A-03/010208, WO-A-03/051934, WO-A-03/051514, WO-A-2004/085499, EP-A-1752462 and EP-A-1739103

Most preferred single site catalyst system is a metallocene catalyst system which means the catalytically active metallocene complex, as defined above, together with a cocatalyst, which is also known as an activator. Suitable activators are metal alkyl compounds and especially aluminium alkyl compounds known in the art. Especially suitable activators used with metallocene catalysts are alkylaluminium oxy-compounds, such as methylalumoxane (MAO), tetraisobutylalumoxane (TIBAO) or hexaisobutylalumoxane (HIBAO).

More preferably the first and second ethylene-1-butene copolymer fractions (A) and (B) are produced in the presence of the same single site catalyst system.

Process Details:

The process for producing the polyethylene composition according to the present invention comprises the following steps:
a) polymerizing ethylene and 1-butene monomers in the presence of a single site catalyst system in a first polymerization reactor to form a first polymerization mixture comprising a first ethylene-1-butene copolymer fraction (A) having a 1-butene content of from 0.5 wt % to 7.5 wt %, based on the total weight amount of monomer units in the first ethylene-1-butene copolymer fraction (A) and a melt flow rate MFR₂ in the range of from 1.0 to less than 50.0 g/10 min, determined according to ISO 1133 at a temperature of 190° C. and a load of 2.16 kg, and said single site catalyst;
b) transferring the first polymerization mixture from the first polymerization reactor to a second polymerization reactor;
c) polymerizing ethylene and 1-butene monomers in the presence of a single site catalyst in said second polymerization reactor to form a second polymerization mixture comprising said first ethylene-1-butene copolymer fraction (A) and a second ethylene-1-butene copolymer fraction (B);
d) recovering said second polymerization mixture from said second reactor;
e) forming a base resin having a density of from 913.0 to 920.0 kg/m³ and a 1-butene content of from 8.0 to 13.0 wt %, based on the total weight amount of monomer units in the base resin, and
f) preparing the polyethylene composition.

The first ethylene-1-butene copolymer fraction produced in process step a) preferably represents the first ethylene-1-butene copolymer fraction (A) as defined above or below.

The second ethylene-1-butene copolymer fraction produced in process step c) preferably represents the second ethylene-1-butene copolymer fraction (B) as defined above or below.

The base resin formed in process step e) preferably represents the base resin as defined above or below.

The temperature in the first reactor, preferably the first slurry phase reactor, more preferably the first loop reactor, is typically from 50 to 115° C., preferably from 60 to 110° C. and in particular from 70 to 100° C. The pressure is typically from 1 to 150 bar, preferably from 1 to 100 bar.

The slurry phase polymerization may be conducted in any known reactor used for slurry phase polymerization. Such reactors include a continuous stirred tank reactor and a loop reactor. It is especially preferred to conduct the polymerization in a loop reactor. In such reactors the slurry is circulated with a high velocity along a closed pipe by using a circulation pump. Loop reactors are generally known in the art and examples are given, for instance, in U.S. Pat. Nos. 4,582,816, 3,405,109, 3,324,093, EP-A-479 186 and U.S. Pat. No. 5,391,654.

It is sometimes advantageous to conduct the slurry phase polymerization above the critical temperature and pressure of the fluid mixture. Such operations are described in U.S. Pat. No. 5,391,654. In such an operation the temperature is typically at least 85° C., preferably at least 90° C. Furthermore the temperature is typically not higher than 110° C., preferably not higher than 105° C. The pressure under these conditions is typically at least 40 bar, preferably at least 50 bar. Furthermore, the pressure is typically not higher than 150 bar, preferably not higher than 100 bar. In a preferred embodiment the slurry phase polymerization step, is carried out under supercritical conditions whereby the reaction temperature and reaction pressure are above equivalent critical points of the mixture formed by hydrocarbon medium, monomer, hydrogen and optional comonomer and the polymerization temperature is lower than the melting temperature of the polymer formed.

The slurry may be withdrawn from the slurry phase reactor either continuously or intermittently. A preferred way of intermittent withdrawal is the use of settling legs where the slurry is allowed to concentrate before withdrawing a batch of the concentrated slurry from the reactor. The use of settling legs is disclosed, amongst others, in U.S. Pat. Nos. 3,374,211, 3,242,150 and EP-A-1 310 295. Continuous withdrawal is disclosed, amongst others, in EP-A-891 990, EP-A-1 415 999, EP-A-1 591 460 and WO-A-2007/025640. The continuous withdrawal is advantageously combined with a suitable concentration method as disclosed in EP-A-1 415 999 and EP-A-1 591 460.

Settling legs are used to concentrate the slurry that is withdrawn from the reactor. The withdrawn stream thus contains more polymer per volume than the slurry within the reactor in average. This has the benefit that less liquid needs to be recycled back to the reactor and thereby the costs of the equipment are lower. In commercial scale plants the fluid which is withdrawn with the polymer evaporates in a flash tank and from there it is compressed with a compressor and recycled into the slurry phase reactor.

However, the settling legs withdraw the polymer intermittently. This causes the pressure and also other variables in the reactor to fluctuate with the period of the withdrawal. Also the withdrawal capacity is limited and depends on the size and number of settling legs. To overcome these disadvantages continuous withdrawal is often preferred.

The continuous withdrawal, on the other hand, has the problem that it typically withdraws the polymer in the same concentration as it is present within the reactor. To reduce the amount of hydrocarbons to be compressed the continuous outlet is advantageously combined with a suitable concentration device, such as a hydrocyclone or sieve, as disclosed in EP-A-1 415 999 and EP-A-1 591 460. The polymer-rich stream is then directed to a flash and the polymer-lean steam is returned directly into the reactor.

For adjusting the melt flow rate of the ethylene-1-butene fraction polymerized in the slurry phase reactor preferably hydrogen is introduced into the reactor.

The hydrogen feed in the first reaction stage is preferably adjusted to the ethylene feed in order to fulfil a hydrogen to ethylene ratio in the first slurry phase reactor of 0.02 to 1.0 mol/kmol, more preferably of 0.03 to 0.5 mol/kmol.

In addition to ethylene monomer 1-butene comonomer is added to the slurry phase reactor in order to produce the first ethylene-1-butene copolymer fraction.

The 1-butene feed in the first reaction stage is preferably adjusted to the ethylene feed in order to fulfil a 1-butene to ethylene ratio in the first slurry phase reactor of 50 to 200 mol/kmol, more preferably of 80 to 150 mol/kmol.

It is preferred that no further comonomer other than 1-butene is introduced into the first slurry phase reactor.

The residence time and the polymerization temperature in the first slurry phase reactor are adjusted as such as to polymerize an ethylene-1-butene copolymer fraction typically in an amount of from 30 to 47 wt %, more preferably of from 32 to 46 wt % and most preferably from 35 to 45 wt % of the total base resin.

Before directing the polymer slurry to the second polymerization reactor it can be subjected to a flashing step for substantially removing hydrocarbons from the polymer slurry. After applying the flashing step, the first polymerization mixture produced in the first slurry reactor preferably is transferred to a second reactor, preferably a gas phase reactor, more preferably a fluidized bed gas phase reactor.

In a fluidised bed gas phase reactor an olefin is polymerized in the presence of a polymerization catalyst in an upwards moving gas stream. The reactor typically contains a fluidised bed comprising the growing polymer particles containing the active catalyst located above a fluidisation grid.

The polymer bed is fluidised with the help of a fluidisation gas comprising the olefin monomer, eventually comonomer(s), eventually chain growth controllers or chain transfer agents, such as hydrogen, and eventually inert gas. The inert gas can thereby be the same or different as the inert gas used in the slurry phase reactor. The fluidisation gas is introduced into an inlet chamber at the bottom of the reactor. To make sure that the gas flow is uniformly distributed over the cross-sectional surface area of the inlet chamber the inlet pipe may be equipped with a flow dividing element as known in the art, e. g. U.S. Pat. No. 4,933,149 and EP-A-684 871.

From the inlet chamber the gas flow is passed upwards through the fluidisation grid into the fluidised bed. The purpose of the fluidisation grid is to divide the gas flow evenly through the cross-sectional area of the bed. Sometimes the fluidisation grid may be arranged to establish a gas stream to sweep along the reactor walls, as disclosed in WO-A-2005/087261. Other types of fluidisation grids are disclosed, amongst others, in U.S. Pat. No. 4,578,879, EP 600 414 and EP-A-721 798. An overview is given in Geldart and Bayens: The Design of Distributors for Gas-fluidised Beds, Powder Technology, Vol. 42, 1985.

The fluidisation gas passes through the fluidised bed. The superficial velocity of the fluidisation gas must be higher than the minimum fluidisation velocity of the particles contained in the fluidised bed, as otherwise no fluidisation would occur. On the other hand, the velocity of the gas should be lower than the onset velocity of pneumatic transport, as otherwise the whole bed would be entrained with the fluidisation gas. The minimum fluidisation velocity and the onset velocity of pneumatic transport can be calculated when the particle characteristics are known by using common engineering practice. An overview is given, amongst others, in Geldart: Gas Fluidisation Technology, J. Wiley & Sons, 1996.

When the fluidisation gas is contacted with the bed containing the active catalyst the reactive components of the gas, such as monomers and chain transfer agents, react in the presence of the catalyst to produce the polymer product. At the same time the gas is heated by the reaction heat.

The unreacted fluidisation gas is then removed from the top of the reactor, compressed and recycled into the inlet chamber of the reactor. Prior to the entry into the reactor fresh reactants are introduced into the fluidisation gas stream to compensate for the losses caused by the reaction and product withdrawal. It is generally known to analyse the composition of the fluidisation gas and introduce the gas components to keep the composition constant. The actual composition is determined by the desired properties of the product and the catalyst used in the polymerization.

After that the gas is cooled in a heat exchanger to remove the reaction heat. The gas is cooled to a temperature which is lower than that of the bed to prevent the bed from being heated because of the reaction. It is possible to cool the gas to a temperature where a part of it condenses. When the liquid droplets enter the reaction zone they are vaporized. The vaporisation heat then contributes to the removal of the reaction heat. This kind of operation is called condensed mode and variations of it are disclosed, amongst others, in WO-A-2007/025640, U.S. Pat. No. 4,543,399, EP-A-699 213, and WO-A-94/25495. It is also possible to add condensing agents into the recycle gas stream, as disclosed in EP-A-696 293. The condensing agents are non-polymerizable components, such as propane, n-pentane, isopentane, n-butane or isobutane, which are at least partially condensed in the cooler.

The polymeric product may be withdrawn from the gas phase reactor either continuously or intermittently. Combinations of these methods may also be used.

Continuous withdrawal is disclosed, amongst others, in WO-A-00/29452.

Intermittent withdrawal is disclosed, amongst others, in U.S. Pat. No. 4,621,952, EP-A-188 125, EP-A-250 169 and EP-A-579 426.

The top part of the at least one gas phase reactor may include a so called disengagement zone. In such a zone the diameter of the reactor is increased to reduce the gas velocity and allow the particles that are carried from the bed with the fluidisation gas to settle back to the bed.

The bed level may be observed by different techniques known in the art. For instance, the pressure difference between the bottom of the reactor and a specific height of the bed may be recorded over the whole length of the reactor and the bed level may be calculated based on the pressure difference values. Such a calculation yields a time-averaged level. It is also possible to use ultrasonic sensors or radioactive sensors. With these methods instantaneous levels may be obtained, which of course may then be averaged over time to obtain time-averaged bed levels.

Also antistatic agent(s) may be introduced into the at least one gas phase reactor if needed. Suitable antistatic agents and methods to use them are disclosed, amongst others, in U.S. Pat. Nos. 5,026,795, 4,803,251, 4,532,311, 4,855,370 and EP-A-560 035. They are usually polar compounds and include, amongst others, water, ketones, aldehydes alcohols.

The reactor may include a mechanical agitator to further facilitate mixing within the fluidised bed. An example of suitable agitator design is given in EP-A-707 513.

The temperature in the gas phase polymerization in the gas phase reactor typically is at least 70° C., preferably at least 80° C. The temperature typically is not more than 105° C., preferably not more than 95° C. The pressure is typically at least 10 bar, preferably at least 15 bar but typically not more than 30 bar, preferably not more than 25 bar.

For adjusting the melt flow rate of the ethylene-1-butene copolymer fraction polymerized in the gas phase reactor hydrogen is preferably introduced into the reactor.

The hydrogen feed is preferably adjusted to the ethylene feed in order to fulfil a hydrogen to ethylene ratio in the gas phase reactor of 0.2 to 1.5 mol/kmol, more preferably of 0.2 to 1.0 mol/kmol and most preferably 0.3 to 0.8 mol/kmol.

In the gas phase reactor the second ethylene-1-butene copolymer fraction is produced.

The 1-butene feed is preferably adjusted to the ethylene feed in order to fulfil a comonomer to ethylene ratio of at least 100 to 300 mol/kmol, more preferably 125 to 225 mol/kmol, most preferably 150 to 200 mol/kmol.

The reaction mixture in the gas phase reactor may contain comonomer different from 1-butene, such as e.g. alpha-olefin comonomer such as 1-hexene. Said comonomer different from 1-butene can be comonomer traces which are residuents from previous polymerization runs in the gas phase reactor. It is also possible to remove the traces of other residual comonomers by techniques known in the art, for example, purging with 1-butene. It is preferred that no comonomer different from 1-butene is fed into the gas phase reactor during the polymerization of the polyethylene composition of the present invention. It is further preferred that no comonomer different from 1-butene is present in the gas phase reactor during the polymerization of the polyethylene composition of the present invention.

The residence time and the polymerization temperature in the gas phase reactor are adjusted as such as to polymerize the second ethylene-1-butene copolymer fraction typically in an amount of from 43 to 65 wt %, more preferably of from 44 to 62 wt % and most preferably from 45 to 60 wt % of the total base resin.

Further, the final base resin emerging from the gas phase reactor, preferably consisting of the first and second ethylene-1-butene copolymer fractions, has a density of from 913.0 kg/m³ to 920.0 kg/m³ and preferably of from 914.0 kg/m³ to 918.0 kg/m³.

The polymerization of first and second ethylene-1-butene copolymer fractions in the first and second polymerization stages may be preceded by a prepolymerization step.

The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step may be conducted in slurry or in gas phase. Preferably prepolymerization is conducted in slurry, preferably in a loop reactor. The prepolymerization is then preferably conducted in an inert diluent, preferably the diluent is a low-boiling hydrocarbon having from 1 to 4 carbon atoms or a mixture of such hydrocarbons.

The temperature in the prepolymerization step is typically from 0 to 90° C., preferably from 20 to 80° C. and more preferably from 40 to 70° C.

The pressure is not critical and is typically from 1 to 150 bar, preferably from 10 to 100 bar.

The single site catalyst system can be fed to any polymerization stage but preferably is fed to the first polymerization stage or the prepolymerization stage, when present. The catalyst components are preferably all introduced to the prepolymerization step. Preferably the reaction product of the prepolymerization step is then introduced to the first polymerization reactor. The prepolymer component is calculated to the amount of the component that is produced in the first actual polymerisation step after the prepolymerisation step, preferably to the amount of the low molecular weight ethylene polymer component.

Compounding

The polyethylene composition of the invention preferably is produced in a multistage process which further comprises a compounding step, wherein the base resin, which is typically obtained as a base resin powder from the reactor, is extruded in an extruder and then pelletized to polymer pellets in a manner known in the art to form the polyolefin composition of the invention.

Optionally, additives or other polymer components can be added to the composition during the compounding step in an amount as described above. Preferably, the composition of the invention obtained from the reactor is compounded in the extruder together with additives and optional polymer(s) different from the first and second ethylene-1-butene copolymer fractions (A) and (B) as defined above in a manner known in the art.

The extruder may be e.g. any conventionally used extruder. As an example of an extruder for the present compounding step may be those supplied by Japan Steel works, Kobe Steel or Farrel-Pomini, e.g. JSW 460P or JSW CIM90P.

Film Production

Polymeric films are usually produced by blown film extrusion or by cast film extrusion.

In the case of multi-layered films several layers of a film can be coextruded or laminated during blown film extrusion or cast film extrusion.

These processes are well known in the art and are easily adaptable for producing films comprising the polyethylene composition according to the present invention.

Use

The present invention further relates to the use of the polyethylene composition as defined above or below for the production of an article such as a film as described above or below.

### EXAMPLES

1. Determination Methods
a) Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylene. MFR may be determined at different loadings such as 2.16 kg (MFR₂), 5 kg (MFR₅) or 21.6 kg (MFR₂₁).

Calculation of MFR₂ (190° C., 2.16 kg) of the second ethylene-1-butene copolymer fraction (B)

Calculation of the MFR₂ (190° C., 2.16 kg) of the second ethylene-1-butene copolymer fraction (B).

$$MFR ( B ) = {10}^{[ \frac{log ( MFR ( A + B ) ) - w ( A ) \times log ( MFR ( A ) )}{w ( B )} ]}$$

wherein
w(A) is the weight fraction [in wt %] of the first ethylene-1-butene copolymer fraction (A) in the blend of polymer fractions A and B,
w(B) is the weight fraction [in wt %] of the second ethylene-1-butene copolymer fraction (B) in the blend of polymer fractions A and B,
MFR(A) is the melt flow rate MFR₂ (190° C., 2.16 kg) [in g/10 min] of the first ethylene-1-butene copolymer fraction (A),
MFR(A+B) is the melt flow rate MFR₂ (190° C., 2.16 kg) [in g/10 min] of the blend of polymer fractions A and B,
MFR(B) is the calculated melt flow rate MFR₂ (190° C., 2.16 kg) [in g/10 min] of the second ethylene-1-butene copolymer fraction (B).
b) Density

Density of the polymer was measured according to ASTM; D792, Method B (density by balance at 23° C.) on compression moulded specimen prepared according to EN ISO 1872-2 (February 2007) and is given in kg/m³.

Calculation of the density of the second ethylene-1-butene copolymer fraction (B)

Calculation of the density of the second ethylene-1-butene copolymer fraction (B):

$$\frac{density ( A + B ) - w ( A ) \times density ( A )}{w ( B )} = density ( B )$$

wherein
w(A) is the weight fraction [in wt %] of the first ethylene-1-butene copolymer fraction (A) in the blend of polymer fractions A and B,
w(B) is the weight fraction [in wt %] of the second ethylene-1-butene copolymer fraction (B) in the blend of polymer fractions A and B,
density(A) is the density [in kg/m³] of the first ethylene-1-butene copolymer fraction (A),
density(A+B) is the density [in kg/m³] of the blend of polymer fractions A and B,
density(B) is the calculated density [in kg/m³] of the second ethylene-1-butene copolymer fraction (B).
c) Molecular weights, molecular weight distribution (Mn, Mw, MWD)—GPC

A PL 220 (Agilent) GPC equipped with a refractive index (RI), an online four capillary bridge viscometer (PL-BV 400-HT), and a dual light scattering detector (PL-LS 15/90 light scattering detector) with a 15° and 90° angle was used. 3× Olexis and 1× Olexis Guard columns from Agilent as stationary phase and 1,2,4-trichlorobenzene (TCB, stabilized with 250 mg/L 2,6-Di tert butyl-4-methyl-phenol) as mobile phase at 160° C. and at a constant flow rate of 1 mL/min was applied. 200 μL of sample solution were injected per analysis. All samples were prepared by dissolving 8.0-12.0 mg of polymer in 10 mL (at 160° C.) of stabilized TCB (same as mobile phase) for 2.5 hours for PP or 3 hours for PE at 160° C. under continuous gentle shaking. The injected concentration of the polymer solution at 160° C. (c_{160° C.}) was determined in the following way.

$${c}_{160 ° C .} = \frac{{w}_{25}}{{V}_{25}} * 0 , 8772$$

With: w₂₅ (polymer weight) and V₂₅ (Volume of TCB at 25° C.).

The corresponding detector constants as well as the inter detector delay volumes were determined with a narrow PS standard (MWD=1.01) with a molar mass of 132900 g/mol and a viscosity of 0.4789 dl/g. The corresponding dn/dc for the used PS standard in TCB is 0.053 cm³/g. The calculation was performed using the Cirrus Multi-Offline SEC-Software Version 3.2 (Agilent).

The molar mass at each elution slice was calculated by using the 15° light scattering angle. Data collection, data processing and calculation were performed using the Cirrus Multi SEC-Software Version 3.2. The molecular weight was calculated using the option in the Cirrus software “use LS 15 angle” in the field “sample calculation options subfield slice MW datafrom”. The dn/dc used for the determination of molecular weight was calculated from the detector constant of the RI detector, the concentration c of the sample and the area of the detector response of the analysed sample.

This molecular weight at each slice is calculated in the manner as it is described by C. Jackson and H. G. Barth (C. Jackson and H. G. Barth, “Molecular Weight Sensitive Detectors” in: Handbook of Size Exclusion Chromatography and related techniques, C.-S. Wu, 2^{nd} ed., Marcel Dekker, New York, 2004, p. 103) at low angle.

For the low and high molecular region in which less signal of the LS detector or RI detector respectively was achieved a linear fit was used to correlate the elution volume to the corresponding molecular weight. Depending on the sample the region of the linear fit was adjusted.

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-4:2003 and ASTM D 6474-99 using the following formulas:

$${M}_{n} = \frac{{\sum }_{i = 1}^{N} {A}_{i}}{\sum ( {A}_{i} / {M}_{i} )} \qquad ( 1 )$$

$${M}_{w} = \frac{{\sum }_{i = 1}^{N} ( {A}_{i} \times {M}_{i} )}{\sum {A}_{i}} \qquad ( 2 )$$

$${M}_{z} = \frac{{\sum }_{i = 1}^{N} ( {A}_{i} \times {M}_{i}^{2} )}{\sum ( {A}_{i} / {M}_{i} )} \qquad ( 3 )$$

For a constant elution volume interval ΔVᵢ, where Aᵢ and Mᵢ are the chromatographic peak slice area and polyolefin molecular weight (MW) determined by GPC-LS.
d) Comonomer Contents:

Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Advance III 500 NMR spectrometer operating at 500.13 and 125.76 MHz for ¹H and ¹³C respectively. All spectra were recorded using a ¹³C optimised 7 mm magic-angle spinning (MAS) probehead at 150° C. using nitrogen gas for all pneumatics.

Approximately 200 mg of material was packed into a 7 mm outer diameter zirconia MAS rotor and spun at 4 kHz. This setup was chosen primarily for the high sensitivity needed for rapid identification and accurate quantification. {klimke06, parkinson07, castignolles09} Standard single-pulse excitation was employed utilising the NOE at short recycle delays{pollard04, klimke06} and the RS-HEPT decoupling scheme{fillip05,griffinO7}. A total of 1024 (1 k) transients were acquired per spectra.

Quantitative ¹³C{¹H} NMR spectra were processed, integrated and relevant quantitative properties determined from the integrals. All chemical shifts are internally referenced to the bulk methylene signal (S+) at 30.00 ppm.

The amount of ethylene was quantified using the integral of the methylene (δ+) sites at 30.00 ppm accounting for the number of reporting sites per monomer:

E=I_{δ+}/2

the presence of isolated comonomer units is corrected for based on the number of isolated comonomer units present:

Etotal=E+(3*B+2*H)/2

where B and H are defined for their respective comonomers. Correction for consecutive and non-consecutive commoner incorporation, when present, is undertaken in a similar way.

Characteristic signals corresponding to the incorporation of 1-butene were observed and the comonomer fraction calculated as the fraction of 1-butene in the polymer with respect to all monomer in the polymer:

fBtotal=(Btotal/(Etotal+Btotal+Htotal)

The amount isolated 1-butene incorporated in EEBEE sequences was quantified using the integral of the *B2 sites at 38.3 ppm accounting for the number of reporting sites per comonomer:

B=I_{*B}2

The amount consecutively incorporated 1-butene in EEBBEE sequences was quantified using the integral of the ααB2B2 site at 39.4 ppm accounting for the number of reporting sites per comonomer:

BB=2*IααB2B2

The amount non consecutively incorporated 1-butene in EEBEBEE sequences was quantified using the integral of the ββB2B2 site at 24.7 ppm accounting for the number of reporting sites per comonomer:

BEB=2*IββB2B2

Due to the overlap of the *B2 and *βB2B2 sites of isolated (EEBEE) and non-consecutivly incorporated (EEBEBEE) 1-butene respectively the total amount of isolated 1-butene incorporation is corrected based on the amount of non-consecutive 1-butene present:

B=I_{*B2}−2*I_{ββB2B2}

The total 1-butene content was calculated based on the sum of isolated, consecutive and non consecutively incorporated 1-butene:

Btotal=B+BB+BEB

The total mole fraction of 1-butene in the polymer was then calculated as:

fB=(Btotal/(Etotal+Btotal+Htotal)

Characteristic signals corresponding to the incorporation of 1-hexene were observed and the comonomer fraction calculated as the fraction of 1-hexene in the polymer with respect to all monomer in the polymer:

fHtotal=(Htotal/(Etotal+Btotal+Htotal)

The amount isolated 1-hexene incorporated in EEHEE sequences was quantified using the integral of the *B4 sites at 39.9 ppm accounting for the number of reporting sites per comonomer:

H=I_{*B}4

The amount consecutively incorporated 1-hexene in EEHHEE sequences was quantified using the integral of the ααB4B4 site at 40.5 ppm accounting for the number of reporting sites per comonomer:

HH=2*IααB4B4

The amount non consecutively incorporated 1-hexene in EEHEHEE sequences was quantified using the integral of the ββB4B4 site at 24.7 ppm accounting for the number of reporting sites per comonomer:

HEH=2*IββB4B4

The total mole fraction of 1-hexene in the polymer was then calculated as:

fH=(Htotal/(Etotal+Btotal+Htotal)

The mole percent comonomer incorporation is calculated from the mole fraction:

B[mol %]=100*fB

H[mol %]=100*fH

The weight percent comonomer incorporation is calculated from the mole fraction:

B[wt %]=100*(fB*56.11)/((fB*56.11)+(fH*84.16)+((1−(fB+f1))*28.05))

H[wt %]=100*(fH*84.16)((fB*56.11)+(fH*84.16)+((1−(fB+f1))*28.05))

### REFERENCES

klimke06
Klimke, K., Parkinson, M., Piel, C., Kaminsky, W., Spiess, H. W., Wilhelm, M., Macromol. Chem. Phys. 2006; 207:382.
parkinson07
Parkinson, M., Klimke, K., Spiess, H. W., Wilhelm, M., Macromol. Chem. Phys. 2007; 208:2128.
pollard04
Pollard, M., Klimke, K., Graf, R., Spiess, H. W., Wilhelm, M., Sperber, O., Piel, C., Kaminsky, W., Macromolecules 2004; 37:813.
filip05
Filip, X., Tripon, C., Filip, C., J. Mag. Resn. 2005, 176, 239 griffin07
Griffin, J. M., Tripon, C., Samoson, A., Filip, C., and Brown, S. P., Mag. Res. in Chem. 2007 45, Si, S198
castignolles09
Castignolles, P., Graf, R., Parkinson, M., Wilhelm, M., Gaborieau, M., Polymer 50 (2009) 2373
busico01
Busico, V., Cipullo, R., Prog. Polym. Sci. 26 (2001) 443
busico97
Busico, V., Cipullo, R., Monaco, G., Vacatello, M., Segre, A. L., Macromoleucles 30 (1997) 6251
zhou07
Zhou, Z., Kuemmerle, R., Qiu, X., Redwine, D., Cong, R., Taha, A., Baugh, D.

Winniford, B., J. Mag. Reson. 187 (2007) 225
busico07
Busico, V., Carbonniere, P., Cipullo, R., Pellecchia, R., Severn, J., Talarico, G., Macromol. Rapid Commun. 2007, 28, 1128
resconi00
Resconi, L., Cavallo, L., Fait, A., Piemontesi, F., Chem. Rev. 2000, 100, 1253

Calculation of 1-butene comonomer content of the second ethylene-1-butene copolymer fraction (B)

Calculation of the amount of the 1-butene content of the second ethylene-1-butene copolymer fraction (B):

$$\frac{C ( A + B ) - w ( A ) \times C ( A )}{w ( B )} = C ( B )$$

wherein
w(A) is the weight fraction [in wt %] of the first ethylene-1-butene copolymer fraction (A) in the blend of polymer fractions A and B,
w(B) is the weight fraction [in wt %] of the second ethylene-1-butene copolymer fraction (B) in the blend of polymer fractions A and B,
C(A) is the 1-butene comonomer content [in wt %] of the first ethylene-1-butene copolymer fraction (A),
C(A+B) is the 1-butene comonomer content [in wt %] of the blend of polymer fractions A and B,
C(B) is the calculated 1-butene comonomer content [in wt %] of the second ethylene-1-butene copolymer fraction (B).
e) Tensile Properties of Films

Film tensile properties are measured at 23° C. according to ISO 527-3 with a specimen Type 2 using 40 μm thick blown film. The film samples were produced as described below under “Experimental part”.

Tensile modulus in machine direction (TM-MD) and Tensile modulus in transverse direction (TM-TD) were measured as 1% secant modulus with 5 mm/min test speed and 50 mm gauge length according to ASTM D882.

Tensile strength at break (TSB-MD and TSB-TD), Tensile strength at yield (TSY-MD and TSY-TD) and Elongation at break (EB-MD) were measured according to ISO 527-3 specimen Type 2 with 50 mm gauge length and 500 mm/min test speed.
f) Tear Strength (Determined as Elmendorf Tear Strength): In Machine Direction (MD) and in Transverse Direction (TD)

Tear testing is conducted according to ASTM 1922 on 40 μm blown films. The film samples were produced as described below under “Experimental part”.

The Elmendorf tear strength is the force in Newton required to propagate tearing across a film specimen. It is measured using a precisely calibrated pendulum device.

Acting by gravity, the pendulum swings through an arc, tearing the specimen from a precut slit. The specimen is held on one side by the pendulum and on the other side by a stationary member. The loss in energy by the pendulum is indicated by a pointer. The scale indication is a function of the force required to tear the specimen. The selection of pendulum weight was based on the absorb energy of the specimen, preferred between 20-80% of pendulum capacity. There is no direct linear relationship between tearing force and specimen thickness. Therefore only data obtained at the same thickness range should be compared.
g) Puncture Resistance

Protrusion Puncture Resistance testing is conducted according to ASTM D5748 on 40 μm blown films. This test method determines the resistance of a film sample to the penetration of a probe with specific size of 19 mm diameter pear-shaped TFE fluorocarbon coated at a standard low rate, a single test velocity (250 mm/min). Performed at standard conditions, the test method imparts a biaxial stress loading. Cut the film specimens 150 mm×150 mm to fit into the jig and conditioning done at 23±2° C. at 50±5% relative humidity.

The Puncture Resistance Force (N) is the maximum force or highest force observed during the test and Puncture Resistance Energy (J) is the energy used until the probe breaks the test specimen, both are measured using the high accuracy 500N loadcell and crosshead position sensor.
h) Dart Drop Strength

Dart-drop is measured using ISO7765-1, method A (Alternative Testing Technique) from the film samples. A dart with a 38 mm diameter hemispherical head is dropped from a height of 0.66 m onto a film clamped over a hole. Successive sets of twenty specimens are tested. One weight is used for each set and the weight is increased (or decreased) from set to set by uniform increments. The weight resulting in failure of 50% of the specimens is calculated and reported.
i) Sealing Properties:

Hot tack temperature and Hot tack force were measured according to ASTM F 1921-98 (2004), method B, using film samples with thickness of 40 μm, which were produced as described below under “Experimental part”. The following settings for Hot tack at hot tack temperature were used:

Hot Tack temperature (lowest temperature to get maximum Hot tack force) and Hot tack (maximum Hot tack force) were measured according to below settings:

| Q-name instrument: | Hot Tack-Sealing Tester | |
|---|---|---|
| Model: | J&B model 4000 MB | |
| Sealbar length: | 50 | [mm] |
| Seal bar width: | 5 | [mm] |
| Seal bar shape: | flat | |
| Coating of sealing bars: | NIPTEF ® | |
| Roughness of sealing bars: | 1 | [μm] |
| Sealing temperature: | variable [° C.] | |
| Sealing time: | 1 | [s] |
| Cooling time: | 0.2 | [s] |
| Sealing pressure: | 0.15 | [N/mm²] |
| Clamp separation rate: | 200 | [mm/s] |
| Sample width: | 25 | [mm] |

Sealing Temperature:

settings as followed below were used. The film samples of 40 μm thickness were produced as described below under “Experimental part”.

| Q-name instrument: | Hot Tack-Sealing Tester 2 | |
|---|---|---|
| Model: | J&B model 4000 MB | |
| Sealbar length: | 50 | [mm] |
| Seal bar width: | 5 | [mm] |
| Seal bar shape: | flat | |
| Coating of sealing bars: | NIPTEF ® | |
| Roughness of sealing bars: | 1 | [μm] |
| Sealing temperature: | variable [° C.] | |
| Sealing time: | 1 | [s] |
| Cooling time: | 30 | [s] |
| Sealing pressure: | 0.4 | [N/mm²] |
| Clamp separation rate: | 42 | [mm/s] |
| Sample width: | 25 | [mm] |

j) Haze

Haze was measured according to ASTM D 1003 on film samples with thickness of 40 μm, which were produced as described below under “Experimental part”.
k) Gloss

Gloss was measured at angles of 20°, 65° and 85° according to ISO 2813 in the inside surface of film samples with thickness of 40 μm, which were produced as described below under “Experimental part”.
l) Gel Content Determination:

Gel Count:

A cast film sample of about 70 μm thickness, is extruded and examined with a CCD (Charged-Coupled Device) camera, image processor and evaluation software (Instrument: OCS-FSA100, supplier OCS GmbH (Optical Control System)). The film defects are measured and classified according to their size (longest dimension).

Cast film preparation, extrusion parameters:
1. Output 25±4 g/min
2. Extruder temperature profile: 230-230-230-220-210 (Melt temp 223° C.)
3. Film thickness about 70 μm
4. Chill Roll temperature 55-65° C.
5. No Airkife needed

Technical data for the extruder:
1. Screw type: 3 Zone, nitrated
2. Screw diameter: 25 mm
3. Screw length: 25D
4. Feeding zone: 10D
5. Compression zone: 4D
6. Die 100 mm

The defects were classified according to the size (μm)/m²:
100-299
300-599
600-999
>999
2. Experimental Part
a) Preparation of Examples
Catalyst preparation

130 grams of a metallocene complex bis(1-methyl-3-n-butylcyclopentadienyl) zirconium (IV) dichloride (CAS no. 151840-68-5), and 9.67 kg of a 30% solution of commercial methylalumoxane (MAO) in toluene were combined and 3.18 kg dry, purified toluene was added. The thus obtained complex solution was added onto 17 kg silica carrier Sylopol 55 SJ (supplied by Grace) by very slow uniform spraying over 2 hours. The temperature was kept below 30° C. The mixture was allowed to react for 3 hours after complex addition at 30° C.
Polymerisation of Inventive Example IE1:

Prepolymerisation:

A loop reactor having a volume of 50 dm³ was operated at a temperature of 60° C. and a pressure of 65 bar. Into the reactor were introduced 2.5 kg/h ethylene, 30 kg/h propane diluent and 50 g/h 1-butene. Also 16 g/h of catalyst as described above was introduced into the reactor. The polymer production rate was about 2 kg/h.

Polymerisation:

The slurry from the reactor was withdrawn intermittently and directed into a loop reactor having a volume of 500 dm³ and which was operated at 85° C. temperature and 64 bar pressure. Into the reactor was further added 25 kg/h of propane and ethylene together with 1-butene comonomer and hydrogen so that the ethylene content in the reaction mixture was 4 mol-%, the molar ratio of hydrogen to ethylene was 0.08 mol/kmol and the ratio of 1-butene to ethylene was 110 mol/kmol. The production rate of ethylene copolymer having a melt index MFR₂ of 6.0 g/10 min and density of 940 kg/m³ was 50 kg/h.

The slurry was withdrawn from the loop reactor intermittently by using settling legs and directed to a flash vessel operated at a temperature of 50° C. and a pressure of 3 bar. From there the polymer was directed to a gas phase reactor (GPR) operated at a pressure of 20 bar and a temperature of 75° C. Additional ethylene, 1-butene comonomer, nitrogen as inert gas and hydrogen were added so that the ethylene content in the reaction mixture was 37 mol-%, the ratio of hydrogen to ethylene was 0.35 mol/kmol and the ratio of 1-butene to ethylene was 175 mol/kmol. The polymer production rate in the gas phase reactor was 70 kg/h and thus the total polymer withdrawal rate from the gas phase reactor was 122 kg/h. The polymer had a melt index MFR₂ of 1.5 g/10 min and a density of 918 kg/m³. The production split (% Loop/% GPR components) was 42/58. The amount of the prepolymerisation product was calculated to the amount of the Loop product.

The polymer was mixed with 1920 ppm of Irgafos 168, 480 ppm Irganox 1010 (both commercially available from BASF SE) and 270 ppm Dynamar FX5922 (commercially available from 3M Company). Then it was compounded and extruded under nitrogen atmosphere to pellets by using a CIMP90 extruder so that the SEI was 230 kWh/kg and the melt temperature 250° C.
Polymerisation of Inventive Example IE2:

The polymer fractions of inventive example IE2 were produced as the inventive example 1, but using the polymerisation conditions as given in Table 1. The polymer was mixed with 2400 ppm of Irgafos 168, 600 ppm Irganox 1010 (both commercially available from BASF SE), 400 ppm Dynamar FX5922 (commercially available from 3M Company), 1000 ppm Crodamide ER (commercially available from Croda), 1875 ppm Silton JC-30 (commercially available from Mizusawa Ind. Chem) and 625 ppm Silton JC-50 (commercially available from Mizusawa Ind. Chem). Then it was compounded and extruded under nitrogen atmosphere to pellets by using a CIMP90 extruder so that the SEI was 230 kWh/kg and the melt temperature 250° C.
Polymerisation of Reference Example RE3:

The polymer fractions of reference example RE3 were produced as the inventive example 1, but using the polymerisation conditions as given in Table 1. In the gas phase reactor 1-hexene was used as comonomer instead of 1-butene. The same additive package as for the inventive polymer of IE11 was used.
Preparation of blend compositions:

Inv. blend IE1:

90 wt % of the final polymer composition of inventive example IE1 and 10 wt % of commercial linear low density polyethylene produced in a high pressure process, sold under tradename FT5230 (supplier Borealis, MFR₂: 0.75 g/10 min; Density: 923 kg/m³, Tensile modulus MD of 230 MPa).

Inv. blend 1E2:

90 wt % of the final polymer composition of inventive example IE2 and 10 wt % of FT5230.

Ref. Blend RE3:

90 wt % of the final polymer composition of reference example RE3 and 10 wt % of FT5230.

Comp. Blend CE4:

90 wt % of the final polymer composition of LLDPE grade 118 W for blown film extrusion (commercially available from Sabic), being a unimodal metallocene catalysed ethylene-1-butene copolymer with an MFR₂ of 1.0 g/10 min, a density of 918 kg/m³ and a tensile modulus MD of 220 MPa, and 10 wt % FT5230.

Weight %'s are based on the combined amount of the two polymer components.
Film sample preparation

The test films consisting of the blend compositions as described above of 40 μm thickness, were prepared using 5 layer coextrusion blown film line (Hosokawa Alpine)

The equipment had 5 extruders, 4 extruders of the equipment screw diameters of 65 mm and 1 extruder of 90 mm (middle extruder is the biggest one). The die width was: 400 mm, die gap 1.8 mm, film thickness 40 μm.
blow-up ratio (BUR): 2.5
temperature profile, ° C.: 30-190-190-190-190-190-195-195-195-same extruder temperature profile for all 5 extruders, with a throughput of 60 kg/h per extruder
die temperature 205° C., same die temperature profile for all 5 extruders
FLH: 2 times die diameter

The two polymer components of the blend compositions were dry-blended before feeding to the extruder.

TABLE 1
Polymersation conditions and polymer properties

| | Unit | IE1 | IE2 | RE3 |
|---|---|---|---|---|
| Polymerisation | | | | |
| conditions and | | | | |
| polymer properties | | | | |
| Prepolymerisation | | | Same as IE1 | Same as IE1 |
| Loop H2/C2 | mol/kmol | 0.08 | 0.08 | 0.08 |
| Loop C4/C2 | mol/kmol | 110 | 110 | 110 |
| Loop MFR₂ | g/10 min | 6.0 | 6.0 | 6.0 |
| Loop Density | kg/m³ | 940 | 940 | 940 |
| C4 content in Loop | mol % | 0.45 | 0.45 | 0.45 |
| GPR H2/C2 | mol/kmol | 0.35 | 0.35 | 0.35 |
| GPR C4/C2 | mol/kmol | 175 | 175 | 195 |
| (RE3: C6/C2) | | | | |
| Production split | wt %/wt % | 42%/58% | 42%/58% | 42%/58% |
| (Loop/GPR) | | | | |
| Final MFR₂ | g/10 min | 1.5 | 1.5 | 1.5 |
| Final Density | kg/m³ | 915 | 915 | 915 |
| Properties of the | | | | |
| final polymer | | | | |
| composition | | | | |
| MFR₂ | g/10 min | 1.5 | 1.5 | 1.5 |
| Density | kg/m³ | 918 | 918 | 918 |
| MFR₂₁/MFR₂ ratio | | 20 | 20 | |
| Comonomer content | wt % | 10.5 | 10.5 | 12 |
| of final product | | | | (C4 + C6) |
| Gel count/m² | pcs/kg | 0-60 | 0-60 | |
| (600-999 μm) | | | | |
| Gel count/m² | pcs/kg | 0-6 | 0-6 | |
| (>999 μm) | | | | |
| MFR_{21, 6} | g/10 min | 22 | 22 | |

TABLE 2
Properties of the blown films of blend
compositions IE1, IE2, RE3 and CE4

| | Unit | IE1 | IE2 | RE3 | CE4 |
|---|---|---|---|---|---|
| Tensile Modulus (MD) | MPa | 209 | 189 | 218 | 192 |
| Tensile Modulus (TD) | MPa | 255 | 233 | 250 | 220 |
| TSY—MD | MPa | 15.7 | 15.2 | 15.7 | 14.4 |
| TSY—TD | MPa | 11.6 | 11.3 | 11.6 | 10.6 |
| TSB—MD | MPa | 48.6 | 44.7 | 45.7 | 38.8 |
| TSB—TD | MPa | 35.0 | 35.9 | 41.9 | 30.7 |
| EB—MD | % | 620 | 617 | 544 | 554 |
| EB—TS | % | 710 | 794 | 656 | 660 |
| Tear Strength (MD) | N | 0.9 | 1.1 | 3.4 | 2.4 |
| Tear Stength (TD) | N | 6.3 | 7.0 | 9.7 | 10.0 |
| Tear Strength (MD) | g | 91 | 116 | 347 | 246 |
| Tear Stength (TD) | g | 644 | 718 | 986 | 1019 |
| Puncture max force | N | 38.1 | 27.5 | 30.3 | 32.2 |
| Puncture force at break | N | 31.7 | 27.0 | 30.2 | 32.2 |
| Puncture travel at break | mm | 80.9 | 51.1 | 49.6 | 52.5 |
| Puncture energy to break | J | 2.2 | 1.0 | 1.1 | 1.2 |
| DDI | g | 170 | 205 | 345 | 70 |
| SIT | ° C. | 96 | 96 | 91 | 106 |
| Hot Tack | ° C. | 94 | 94 | 85 | 98 |
| Haze | % | 9.0 | 11.8 | 8.2 | 14.2 |
| Gloss | % | 99 | 101 | 100 | 91 |

The films comprising the polyethylene compositions of inventive examples IE1 and IE2 show a balance of properties which is comparable with that of the film comprising the polyethylene composition of reference example RE3. Especially, it was expected that the SIT of the IE1 and IE2 to show a significantly higher SIT compared to RE3 that contains 1-hexene comonomer. Surprisingly, the SIT of the inventive examples is comparable to that of RE3. The films comprising the polyethylene compositions of inventive examples IE1 and IE2 show an improved behavior in regard of impact properties (DDI), sealing properties (SIT and hot tack) and optical properties (haze and gloss) compared to the film comprising the polyethylene composition of comparative example CE4.

1. A polyethylene composition comprising a base resin, wherein the base resin comprises
(A) a first ethylene-1-butene copolymer fraction (A) having a 1-butene content of from 0.5 wt % to 7.5 wt %, based on the total weight amount of monomer units in the first ethylene-1-butene copolymer fraction (A), and a melt flow rate MFR₂ in the range of from 1.0 to less than 50.0 g/10 min, determined according to ISO 1133 at a temperature of 190° C. and a load of 2.16 kg; and
(B) a second ethylene-1-butene copolymer fraction (B) having a higher 1-butene content than the first ethylene-1-butene copolymer fraction;
wherein the base resin is polymerized in the presence of a single site catalyst system and has a density of from 913.0 to 920.0 kg/m³ and a 1-butene content of from 8.0 to 13.0 wt %, based on the total weight amount of monomer units in the base resin.

2. The polyethylene composition according to claim 1 having a melt flow rate MFR₂ of 0.7 to 4.0 g/10 min, determined according to ISO 1133 at a temperature of 190° C. and a load of 2.16 kg.

3. The polyethylene composition according to claim 1 having a melt flow rate MFR₂₁ of 15 to 50 g/10 min, determined according to ISO 1133 at a temperature of 190° C. and a load of 21.6 kg and/or a flow rate ratio FRR_{21/2}, being the ratio of the melt flow rates MFR₂₁/MFR₂, of from 10 to 30.

4. The polyethylene composition according to claim 1 having a polydispersity index PDI, being the ratio of weight average molecular weight Mw to number average molecular weight Mn, Mw/Mn, of from 3 to 8.

5. The polyethylene composition according to claim 1, wherein the weight ratio of the first ethylene-1-butene copolymer (A) to the second ethylene-1-butene copolymer (B) in the base resin is from 35:65 to 47:53.

6. The polyethylene composition according to claim 1, wherein the base resin further comprises up to 15 wt % of a low density polyethylene (LDPE).

7. A process for preparing the polyethylene composition according to claim 1 comprising
a) polymerizing ethylene and 1-butene monomers in the presence of a single site catalyst system in a first polymerization reactor to form a first polymerization mixture comprising a first ethylene-1-butene copolymer fraction (A) having a 1-butene content of from 0.5 wt % to 7.5 wt %, based on the total weight amount of monomer units in the first ethylene-1-butene copolymer fraction (A) and a melt flow rate MFR₂ in the range of from 1.0 to less than 50.0 g/10 min, determined according to ISO 1133 at a temperature of 190° C. and a load of 2.16 kg, and said single site catalyst;
b) transferring the first polymerization mixture from the first polymerization reactor to a second polymerization reactor;
c) polymerizing ethylene and 1-butene monomers in the presence of a single site catalyst in said second polymerization reactor to form a second polymerization mixture comprising said first ethylene-1-butene copolymer fraction (A) and a second ethylene-1-butene copolymer fraction (B);
d) recovering said second polymerization mixture from said second reactor;
e) forming a base resin having a density of from 913.0 to 920.0 kg/m³ and a 1-butene content of from 8.0 to 13.0 wt %, based on the total weight amount of monomer units in the base resin, and
f) preparing the polyethylene composition.

8. An article comprising the polyethylene composition according to claim 1.

9. The article according to claim 8 being a film, a blow moulded article or a rotomoulded article.

10. The article according to claim 8 being a film, which has a tear strength in machine direction TS-MD (N) of at least 0.6 N and/or a tear strength in transverse direction TS-TD (N) of at least 5.0 N, determined according ISO 6383-2:1983 on a 40 μm thick blown film.

11. The article according to claim 8 being a film, which has a seal initiation temperature SIT of from 90 to 100° C., determined on a 40 μm thick blown film.

12. The article according to claim 8 being a film, which has a hot tack temperature of from 88 to 97° C., determined according to BICM90720 on a 40 μm thick blown film.

13. The article according to claim 8 being a film, which has a haze of not more than 14.0%, determined according to ASTM D1003 on a 40 μm thick blown film.

14. The article according to claim 8 being a film, which has a gloss of at least 92.0%, determined according to ISO2813 on the inside surface of a 40 μm thick blown film.

15. The use of a polyethylene composition according to claim 1 for the production of an article.
